(19) United States
(12) Patent Application Publication
(10) Pub. No.: US 2026/0017095 A1
(43) Pub. Date: Jan. 15, 2026

(54) METHOD FOR ORCHESTRATING DEEP LEARNING MODEL TRAINING EXPERIMENTATION ON A DISTRIBUTED COMPUTING PLATFORM

(71) Applicant: RapidFire AI, Inc., Palo Alto, CA (US)

(72) Inventors: Arun Kumar Kumar, San Diego, CA (US); Pradyumna Sridhara, San Diego, CA (US)

(21) Appl. No.: 19/263,844

(22) Filed: Jul. 9, 2025

Related U.S. Application Data
(60) Provisional application No. 63/669,111, filed on Jul. 9, 2024.

(51) Int. Cl. G06F 9/48; G06F 9/50

(52) U.S. Cl. CPC G06F 9/4881; G06F 9/5077

(57) ABSTRACT

A method includes: partitioning a dataset into data groups; assigning the data groups to a set of workers; generating a first set of workloads including a first workload for training a first model configuration according to the set of data groups; allocating subclusters of resources of the set of workers to the first set of workloads for a first epoch; scheduling concurrent execution of the first set of workloads at the set of workers for the first epoch; calculating a first accuracy value for the first model configuration for the first epoch; in response to the first accuracy value failing to exceed a threshold accuracy value, generating a second set of workloads excluding the first workload; allocating subclusters of resources to the second set of workloads for a second epoch; and scheduling concurrent execution of the second set of workloads at the set of workers for the second epoch.

### CROSS-REFERENCE TO RELATED APPLICATIONS

This application claims the benefit of U.S. Provisional Application No. 63/669,111, filed on 9 Jul. 2024, which is incorporated in its entirety by this reference.

### TECHNICAL FIELD

This invention relates generally to the field of distributed computing and, more specifically, to a new and useful method for orchestrating deep learning model training experimentation on a distributed computing platform within the field of distributed computing.

### BRIEF DESCRIPTION OF THE FIGURES

FIG. 1 is a flowchart representation of a method;

FIG. 2 is a flowchart representation of one variation of the method;

FIG. 3 is a flowchart representation of one variation of the method;

FIG. 4 is a flowchart representation of one variation of the method; and

FIG. 5 is a flowchart representation of one variation of the method.

### DESCRIPTION OF THE EMBODIMENTS

The following description of embodiments of the invention is not intended to limit the invention to these embodiments but rather to enable a person skilled in the art to make and use this invention. Variations, configurations, implementations, example implementations, and examples described herein are optional and are not exclusive to the variations, configurations, implementations, example implementations, and examples they describe. The invention described herein can include any and all permutations of these variations, configurations, implementations, example implementations, and examples.

### 1. Methods

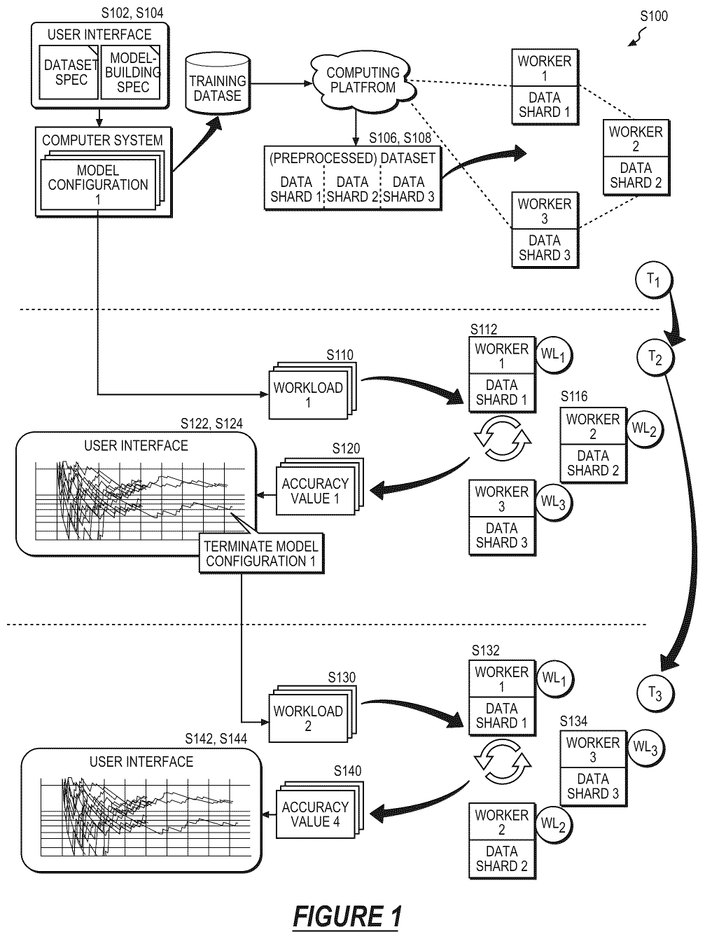

As shown in FIG. 1, a method S100—for orchestrating model—training experimentation on a set of workers including a cluster of resources—includes: accessing a model-building specification in Block S102; accessing a set of model configurations in Block S104; partitioning a dataset into a set of data groups in Block S106; and assigning the set of data groups to the set of workers in Block S108. The model-building specification defines: a set of hyperparameters for training a set of model architectures; and a set of hyperparameter values for the set of hyperparameters. The set of model configurations include: a first model configuration characterized by a first combination of hyperparameter values in the set of hyperparameter values; and a second model configuration characterized by a second combination of hyperparameter values in the set of hyperparameter values.

The method S100 also includes, in Block S110, generating a first set of workloads including: a first workload for training the first model configuration according to the set of data groups; and a second workload for training the second model configuration according to the set of data groups.

The method S100 further includes: allocating subclusters of resources in the cluster of resources to the first set of workloads for a first epoch in a set of epochs in Block S112; scheduling concurrent execution of the first set of workloads at the set of workers via the cluster of resources for the first epoch in Block S116; and calculating a first set of accuracy values representing accuracies of the set of model configurations responsive to execution of the first set of workloads for the first epoch in Block S120. The first set of accuracy values include a first accuracy value representing a first accuracy of the first model configuration for the first epoch.

The method S100 also includes, in Block S130, in response to detection of the first accuracy value failing to exceed a first threshold accuracy value, generating a second set of workloads: including the second workload; and excluding the first workload.

The method S100 further includes: allocating subclusters of resources in the cluster of resources to the second set of workloads for a second epoch in the set of epochs in Block S132; and scheduling concurrent execution of the second set of workloads at the set of workers via the cluster of resources for the second epoch in Block S134.

### 1.1 Variation: Model Configuration Modification

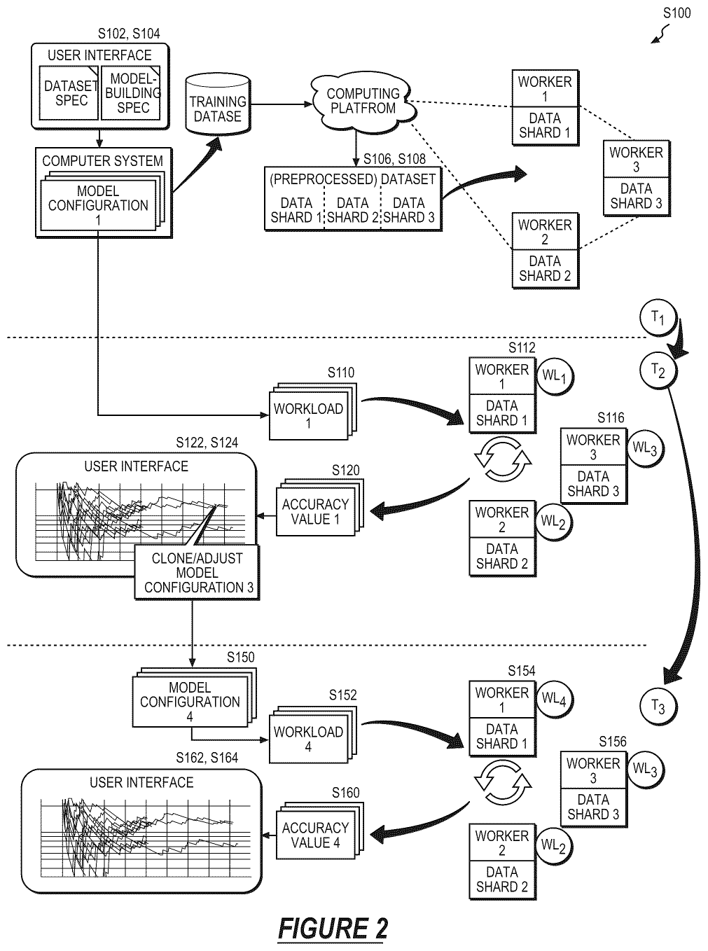

As shown in FIG. 2, one variation of the method S100 includes: accessing a model-building specification in Block S102; accessing a set of model configurations in Block S104; partitioning a dataset into a set of data groups in Block S106; and assigning the set of data groups to the set of workers in Block S108. The model-building specification defines: a set of hyperparameters for training a set of model architectures; and a set of hyperparameter values for the set of hyperparameters. The set of model configurations includes: a first model configuration characterized by a first combination of hyperparameter values in the set of hyperparameter values; and a second model configuration characterized by a second combination of hyperparameter values in the set of hyperparameter values.

This variation of the method S100 also includes, in Block S110, generating a first set of workloads including: a first workload for training the first model configuration according to the set of data groups; and a second workload for training the second model configuration according to the set of data groups.

This variation of the method S100 further includes: allocating subclusters of resources in the cluster of resources to the first set of workloads for a first epoch in a set of epochs in Block S112; scheduling concurrent execution of the first set of workloads at the set of workers via the cluster of resources for the first epoch in Block S116; and calculating a first accuracy value representing a first accuracy of the first model configuration responsive to execution of the first set of workloads for the first epoch in Block S120.

This variation of the method S100 also includes, in Block S150, in response to detection of the first accuracy value exceeding a first threshold accuracy value, defining a second set of model configurations including: the first model configuration; the second model configuration; and a third model configuration based on the first model configuration. The third model configuration is characterized by: the first combination of hyperparameter values; and a target hyperparameter value for a target hyperparameter excluded from the set of hyperparameter values.

This variation of the method S100 further includes, in Block S152, generating a second set of workloads including: the first workload; the second workload; and a third workload for training the third model configuration according to the set of data groups.

The method S100 further includes: allocating subclusters of resources in the cluster of resources to the second set of workloads for a second epoch in the set of epochs in Block S154; and scheduling concurrent execution of the second set of workloads at the set of workers via the cluster of resources for the second epoch in Block S156.

### 1.2 Variation: Single Worker Computing Platform

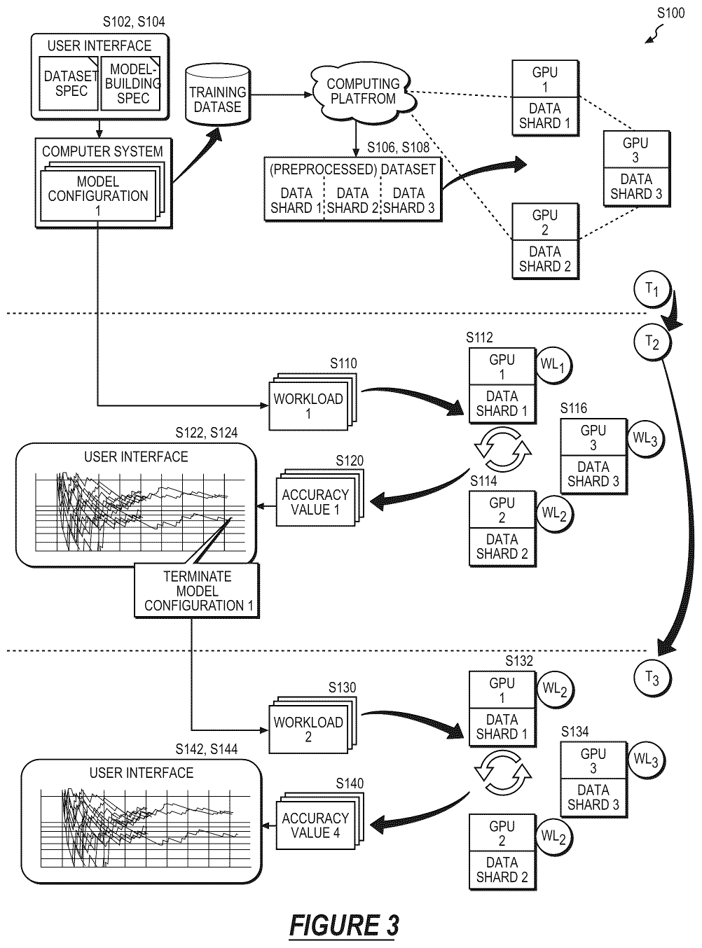

As shown in FIG. 3, one variation of the method S100 includes: accessing a model-building specification in Block S102; and accessing a set of model configurations in Block S104. The model-building specification defines: a set of hyperparameters for training a set of model architectures; and a set of hyperparameter values for the set of hyperparameters. The set of model configurations includes: a first model configuration characterized by a first combination of hyperparameter values in the set of hyperparameter values; and a second model configuration characterized by a second combination of hyperparameter values in the set of hyperparameter values.

This variation of the method S100 also includes, in Block S110, generating a first set of workloads including: a first workload for training the first model configuration according to a dataset; and a second workload for training the second model configuration according to the dataset.

This variation of the method S100 further includes: allocating a first subset of graphics processing units in the set of graphics processing units to the first workload for a first epoch in Block S112; allocating a second subset of graphics processing units in the set of graphics processing units to the second workload for the first epoch in Block S114; scheduling concurrent execution of the first set of workloads at the worker via the set of graphics processing units for the first epoch in Block S116; and calculating a first accuracy value representing a first accuracy of the first model configuration responsive to execution of the first workload for the first epoch in Block S120.

This variation of the method S100 also includes, in Block S130, in response to detection of the first accuracy value failing to exceed a threshold accuracy value, generating a second set of workloads: including the second workload; and excluding the first workload.

This variation of the method S100 also includes: allocating a third subset of graphics processing units in the set of graphics processing units to the second workload for a second epoch in Block S132; and scheduling concurrent execution of the second set of workloads at the worker via the set of graphics processing units for the second epoch in Block S134. The third subset of graphics processing units includes: a graphics processing unit in the first subset of graphics processing units; and the second subset of graphics processing units.

### 2. Applications

Generally, a computer system (hereinafter “the system”)—including or interfacing with a user device (e.g., a laptop computer, a desktop computer, a tablet, a smartphone) and a computing platform (e.g., a distributed computing platform, a centralized computing platform, a single-worker computing platform)—can execute Blocks of the method S100: to access a model-building specification characterizing a set of model configurations based on various model architectures and combinations of hyperparameter values (e.g., batch sizes, learning rates, lambda values, optimizers) from a user, such as a data scientist via a user interface executing on the user device. The computer system can further execute Blocks of the method: to access a dataset specification defining a dataset with which to train the set of model configurations via the user interface; to preprocess and partition the dataset into data groups (or “data shards”) assigned to a set of workers in a computing platform; to launch concurrent training of the set of model configurations at the set of workers according to these data groups; to calculate accuracies of the set of model configurations; to generate a visualization depicting these accuracies; and to serve the visualization to the user via the user interface.

Accordingly, the system can execute Blocks of the method S100: to render a user interface that enables the user to control and monitor model training experimentation; and to elastically launch concurrent training of model configurations on the computing platform at scale while abstracting system architecture and orchestration of the computing platform from the user. Therefore, the computer system can enable the user to focus attention on data science aspects of increasing accuracy during model training experimentation—rather than focusing attention on system scaling, resource management, and/or parallelization—in order to increase user productivity and reduce time to achieving sufficient accuracy of a deep learning model (or “time to accuracy”).

More specifically, the system executes Blocks of the method S100: to generate an interface indicating accuracy values of the set of model configurations; to modify the set of model configurations in response to user input via the interface; and to dynamically adjust resources allocated to these model configurations.

Therefore, by exposing the user to accuracy values of the set of model configurations, the system can: receive a command from the user to terminate a target model configuration (e.g., a target model configuration exhibiting an accuracy failing to exceed a first threshold); and reallocate resources—for training the target model configuration—to other model configurations, thereby reducing time to accuracy during deep learning model training experimentation.

### 2.1 Multidimensional Parallelism

For example, the system can execute Blocks of the method S100: to partition a dataset into data shards assigned to the set of workers; to define workloads for training the set of model configurations according to the data shards; to elastically allocate subsets (or “subclusters”) of resources to these workloads; and to schedule concurrent execution of these workloads at the set of workers via these subsets of resources in order to maximize throughput and graphics processing unit utilization, minimize memory and/or storage utilization, and minimize communication overhead.

More specifically, the system can: define a model configuration characterized by a model architecture—which may exceed memory capacity of a single graphics processing unit resource at a worker—and a combination of hyperparameter values; partition this model architecture into sub-models (or “model shards”); generate a workload for training these sub-models based on the combination of hyperparameter values and the data shards; and schedule execution of this workload at graphics processing units of one or more workers.

Therefore, the system can optimize concurrent execution of workloads at the set of workers—each worker including multiple graphics processing units—in order to scale deep learning model experimentation according to dataset size, model size, and quantity of concurrent model configuration experiments.

### 2.2 Variation: Automation

As described herein, the system executes Blocks of the method S100: to receive a command to terminate a target model configuration via the user interface; and to reallocate resources from the target model configuration to another model configuration(s).

However, the system can similarly execute Blocks of the method S100: to automatically terminate the target model configuration in response to detection of an accuracy of the target model configuration failing to exceed a threshold accuracy; and to reallocate resources from the target model configuration to another model configuration(s).

### 3. Terminology

Generally, a “worker” is referred to herein as a computational unit (e.g., a computer device, a process) that executes tasks as part of a computing platform (e.g., a distributed computing platform, a centralized computing platform).

Generally, a “cluster of resources” is referred to herein as a union of resources (e.g., graphics processing units) available in a set of workers.

Generally, a “subcluster of resources” is referred to herein as a quantity of resources assigned to a workload and mapped to: a subset of resources in a set of resources in a single worker; a set of resources in a single worker; or resources spanning multiple workers.

Generally, a “workload” is referred to herein as a set of tasks (or operations) of a job (e.g., a model-training job) for execution via resources of the computing platform.

Generally, a “model configuration” is referred to herein as a set of settings and/or parameters (e.g., hyperparameter values) that define structure, training, and/or evaluation of a model.

Generally, a “hyperparameter” is referred to herein as a parameter that controls machine learning model training.

Generally, “time to accuracy” is referred to herein as a duration of time to train a model configuration exceeding a threshold level of accuracy.

Generally, an “epoch” is referred to herein as one complete iteration of training a model, which includes processing every example in the training dataset.

Generally, a “sub-epoch” is referred to herein as a segment of one epoch in which a model processes examples in a subset of the training dataset (e.g., a data group).

### 4. System

Generally, the system can include or interface with a user device (e.g., a laptop computer, a desktop computer, a tablet, a smartphone) and a computing platform.

In one example, the computing platform includes a remote computing platform (e.g., a distributed computing platform).

In another example, the computing platform includes a local (or “on-prem”) computing platform (e.g., a centralized computing platform).

In one implementation, the computing platform includes a set of workers (e.g., computer devices). Each worker in the set of workers includes resources, such as compute resources (e.g., central processing unit resources, graphics processing unit resources), memory resources, storage resources, network resources, etc.

In another implementation, the computer system receives a model-building specification from the user device, such as via an interface (e.g., a programmatic application programming interface, a user interface). The model-building specification defines: a set of model architectures; a set of hyperparameters for training the set of model architectures; and, for each hyperparameter in the set of hyperparameters, a subset of hyperparameter values in a set of hyperparameter values associated with the hyperparameter.

In this implementation, the system defines a set of model configurations based on the model-building specification. Each model configuration is characterized by: a model architecture in the set of model architectures; and a combination of hyperparameter values in the set of hyperparameter values.

Additionally, the system receives a dataset specification from the user device, the dataset specification defining a dataset (e.g., a training dataset) with which to train and evaluate the set of model configurations.

In another implementation, the computer system: preprocesses and partitions the dataset into a set of data groups; assigns a data group to each worker in the set of workers; generates a set of workloads for training the set of model configurations; allocates a subcluster of resources-in a cluster of resources in the set of workers-to the set of workloads for training the set of model configurations according to the set of data groups; optimizes apportioning of resources among concurrent model configurations based on resource requirements for each model configuration in the set of model configurations; and schedules concurrent execution (e.g., parallel execution) of the set of workloads at the set of workers via the cluster of resources.

Accordingly, the system can: ingest a model-building specification and a dataset specification—that are agnostic to the cluster of resources and/or the set of workers in the computing platform-via the user interface or the programmatic application programming interface; identify a set of model configurations for training according to a dataset based on the model-building specification and the dataset specification; automatically partition the dataset into the set of data groups based on the set of workers; automatically partition models that exceed memory capacity of a single graphics processing unit; generate a set of workloads for concurrently training the set of model configurations at the set of workers; and orchestrate concurrent execution of the set of workloads at the set of workers.

Therefore, by automatically extracting the set of model configurations from the model-building specification and deploying the set of workloads for concurrent execution at the set of workers of the computing platform, the system can abstract system architecture and orchestration of the computing platform in order to simplify deep learning model training experimentation for a user (e.g., a data scientist) to build, train, and tune deep learning models on large datasets that may exceed sizes storable on the user device and/or work with large models that may exceed the graphics processing unit memory on the user device.

In another implementation, the computer system generates a set of model accuracy values (hereinafter “accuracy values”) representing accuracies of the set of model configurations based on the execution of the set of workloads at the set of workers. The system: generates a visualization depicting the set of accuracies; and serves the visualization to the user via the user interface.

Therefore, by exposing the user to accuracies of the set of model configurations, the system can: receive a command from the user to terminate a target model configuration (e.g., a target model configuration exhibiting an accuracy failing to exceed a first threshold); and reallocate resources from a target workload—for training the target model configuration—to other workloads in the set of workloads, thereby reducing time to accuracy during deep learning model training experimentation.

### 5. Experiment Specification

Block S102 of the method S100 recites accessing a model-building specification defining: a set of hyperparameters for training a set of model architectures; and a set of hyperparameter values for the set of hyperparameters.

Generally, as shown in FIG. 1 and in Block S102, the system can access: a model-building specification characterizing a set of model configurations; and a dataset specification defining a corpus of data (e.g., a dataset) with which to train and evaluate the set of model configurations.

For example, the system can receive the model-building specification and/or the dataset specification via a user interface (e.g., an application, a browser, a web-based interactive computing platform) executing at the user device.

### 5.1 Dataset Specification

In one implementation, the system accesses the dataset specification defining a first location (e.g., a first address of a remote data repository) of a first corpus of data—or a “training dataset”—with which to train the set of model configurations. The dataset specification can define locations of additional data, such as a second corpus of validation data, a third corpus of test data, libraries, etc.

In another implementation, the computer system accesses the dataset specification defining a set of operations (e.g., a data preprocessing function) for preprocessing a target set of data in the training dataset.

For example, the computer system can access the dataset specification defining the set of operations including: a first operation configured to access the target set of data representing an image; a second operation configured to resize the target set of data as a resized target set of data; a third operation configured to generate a target tensor—based on the resized target set of data—as a target set of tensor data; and a fourth operation configured to return (or store) the target set of tensor data.

Therefore, the system can: extract the set of operations from the dataset specification that is agnostic to the computing platform; access the training dataset from the first location; and automatically orchestrate concurrent preprocessing of the training dataset—according to the set of operations—at the set of workers of the computing platform.

### 5.2 Model-Building Specification

In another implementation, in Block S102, the system accesses the model-building specification defining: a set of model architectures; a set of hyperparameters for training the set of model architectures; and a set of hyperparameter values for the set of hyperparameters.

In one example, the system accesses the model-building specification defining a set of model architectures including: a first model architecture; a second model architecture; a third model architecture; etc.

In this example, the first model architecture includes a first large language model characterized by: a first version; and a first quantity of parameters (e.g., 3 billion parameters). The second model architecture includes the first large language model characterized by: the first version; and a second quantity of parameters (e.g., 3 billion parameters). The third model architecture includes a second large language model—different from the first large language model—characterized by: a second version; and a third quantity of parameters (e.g., 3 billion parameters).

In another example, the system accesses the model-building specification defining a set of hyperparameters including: a first hyperparameter for batch size: a second hyperparameter for learning rate; and a third hyperparameter for weight regularization.

In this example, the system accesses the model-building specification defining the set of hyperparameter values including: a first subset of hyperparameter values (e.g., “128,” “256”) for the first hyperparameter; a second subset of hyperparameter values (e.g., “1e-2,” “1e-3”) for the second hyperparameter; and a third subset of hyperparameter values (e.g., “1e-3,” “1e-4”) for the third hyperparameter.

Therefore, the system can identify (or define) a set of model configurations based on the model-building specification, each model configuration characterized by a model architecture and a combination of hyperparameter values in the set of hyperparameter values.

In another implementation, the system accesses the model-building specification defining additional information, such as: a set of locations from which to import the set of model architectures; a quantity of epochs for which to train the set of model configurations; a threshold—based on an accuracy metric—defining at which epoch to cease training of a model configuration(s); an optimizer(s) for training a model configuration; a training function configured to train a model architecture according to the optimizer and/or a combination of hyperparameter values; a set of heuristics for defining hyperparameters and/or hyperparameter values; an accuracy function defining a set of accuracy metrics (e.g., loss, top-1 accuracy, top-5 accuracy) for characterizing the set of model configuration; etc.

### 6. Model Configurations

Block S104 of the method S100 recites accessing a set of model configurations including: a first model configuration characterized by a first combination of hyperparameter values in the set of hyperparameter values; and a second model configuration characterized by a second combination of hyperparameter values in the set of hyperparameter values.

Generally, in Block S104, the system accesses the set of model configurations based on the model-building specification. More specifically, the system can define the set of model configurations based on a hyperparameter grid specifying: the set of hyperparameters; and, for each hyperparameter in the set of hyperparameters, a subset of hyperparameter values in a set of hyperparameter values associated with the hyperparameter.

In one implementation, in Block S104, the system defines the set of model configurations based on the model-building specification, such as via a grid search or random search of the hyperparameter grid and/or via heuristics that automatically construct combinations of hyperparameter values.

In one example, the system defines the set of model configurations including a first model configuration characterized by: the first model architecture; and a first combination of hyperparameter values. The first combination of hyperparameter values include: a first hyperparameter value (e.g., “128”) in the first subset of hyperparameter values for the first hyperparameter (e.g., “batch size”); a second hyperparameter value (e.g., “1e-2”) in the second subset of hyperparameter values for the second hyperparameter (e.g., “learning rate”); and a third hyperparameter value (e.g., “1e-3,”) in the third subset of hyperparameter values for the third hyperparameter (e.g., “weight regularization”).

In another example, the system defines the set of model configurations including a second model configuration characterized by: the first model architecture; and a second combination of hyperparameter values. The second combination of hyperparameter values includes: a fourth hyperparameter value (e.g., “256”) in the first subset of hyperparameter values for the first hyperparameter; the second hyperparameter value for the second hyperparameter; and the third hyperparameter value for the third hyperparameter.

In another example, the system defines the set of model configurations including a third model configuration characterized by the second model architecture, in the set of model architectures, and a third combination of hyperparameter values in the set of hyperparameter values.

Therefore, the system can: define the set of model configurations-characterized by model architectures exceeding sizes executable on the user device-based on the model-building specification that is agnostic to the computing platform; and launch concurrent training of the set of model configurations at the set of workers of the computing platform in order to simplify model training experimentation of these model configurations at scale for the user.

### 7. Data Preprocessing and Deployment

The method S100 includes: partitioning a dataset into a set of data groups in Block S106; and assigning the set of data groups to the set of workers in Block S108.

Generally, in Blocks S106 and S108, the system can: pre-process a training dataset based on the dataset specification; partition the training dataset into a set of data groups; and assign the set of data groups to the set of workers.

### 7.1 Data Preprocessing

In one implementation, the system: accesses the training dataset from the first location; and generates a second dataset (e.g., a “transformed” dataset) by preprocessing the training dataset according to the set of operations defined in the dataset specification.

For example, the system can access the training dataset including sets of data (e.g., “raw” data). For each set of data in the training dataset, the system can: resize the set of data as a resized set of data; generate a tensor—based on the resized set of data—as a set of tensor data; and return the set of tensor data in the second dataset.

In this implementation, the system stores the second dataset in a second location (e.g., a second address of the remote data repository) for later access during additional experimentation.

In one variation, the system executes the foregoing methods and techniques to generate the second dataset by preprocessing—concurrently at the set of workers—the training dataset according to the set of operations.

In this variation, the system: segments the training dataset into a set of data groups; assigns each data group in the set of data groups to a worker in the set of workers; and schedules concurrent execution of the set of operations—on the set of data groups—at the set of workers.

Therefore, the system can: access the training dataset—that may exceed a size that is storable on the user device—based on the dataset specification that is agnostic to the computing platform; and launch concurrent pre-processing of the training dataset at the set of workers of the computing platform in order to reduce computation time and simplify model training experimentation at scale for the user.

### 7.2 Data Partitioning

In another implementation, in Block S106, the system: partitions the dataset (e.g., the transformed dataset) into a set of data groups (or “data shards”); and, for each data group in the set of data groups, assigns the data group to a worker in a set of workers.

More specifically, the system can: calculate a quantity of workers in the set of workers; segment the dataset into the set of data groups according to the quantity of workers; and assign each data group in the set of data groups to a worker in the set of workers.

For example, the system can: identify the set of workers including a first worker, a second worker, and a third worker; calculate a quantity (e.g., three) of workers in the set of workers; and segment the dataset into the set of data groups according to the quantity of workers. The set of data groups can include a first data group, a second data group, and a third data group.

In this example, the system can: assign the first data group to the first worker; assign the second data group to the second worker; and assign the third data group to the third worker.

Therefore, by assigning a data group—rather than the dataset in its entirety—to a worker, the system: enables scalability of the dataset (e.g., exceeding storage capacity of a single computer device); and reduces communication overhead attributed to loading the dataset at each worker in the set of workers.

In one variation, the system assigns a subset of data groups in the set of data groups to a worker in the set of workers.

For example, the system can: assign the first data group and the second data group to the first worker; assign the second data group and the third data group to the second worker; and assign the first data group and the third data group to the third worker.

### 8. Model Building and Orchestration

Block S110 of the method S100 recites generating a first set of workloads including: a first workload for training the first model configuration according to the set of data groups; and a second workload for training the second model configuration according to the set of data groups.

The method S100 includes: allocating subclusters of resources in the cluster of resources to the first set of workloads for a first epoch in a set of epochs in Block S112; and scheduling concurrent execution of the first set of workloads at the set of workers via the cluster of resources for the first epoch in Block S116.

Generally, in Blocks S110, S112, S114, and S116, the system can: generate a set of workloads for training the set of model configurations according to the dataset (e.g., the set of data groups); allocate subsets (or “subclusters”) of resources—in the cluster of resources in the set of workers—to each workload in the set of workloads; and schedule concurrent execution of the set of workloads at the set of workers via the cluster of resources.

Therefore, by automatically generating the set of workloads for training the set of model configurations and scheduling concurrent execution of the set of workloads at the set of workers of the computing platform, the system can maximize resource utilization of the computing platform in order to enable rapid iteration and experimentation for deep learning model training, thereby reducing time to accuracy and minimizing cost to an organization.

### 8.1 Workload Generation

In one implementation, the system generates the set of workloads including a first workload for training the first model configuration according to the set of data groups for a target epoch in a set of epochs of a model-training experiment.

For example, the system can generate the first workload including a first set of tasks configured to train the first model configurations according to the set of data groups. The first set of tasks can include: a first task configured to train the first model configuration (e.g., the first model architecture based on the first combination of hyperparameter values) according to the first data group at the first worker for a first sub-epoch of a first epoch (or a target epoch) in a set of epochs of a model-training experiment; a second task configured to train the first model configuration according to the second data group at the second worker for a second sub-epoch of the first epoch; and a third task configured to train the first model configuration according to the third data group at the third worker for a third sub-epoch of the first epoch.

The system can repeat the foregoing methods and techniques for each model configuration in the set of model configurations to generate a workload configured to train the model configuration according to the set of data groups.

For example, the system can generate a second workload—in the set of workloads—including a second set of tasks configured to train the second model configurations according to the set of data groups. The second set of tasks can include: a first task configured to train the second model configuration (e.g., the first model architecture based on the second combination of hyperparameter values) according to the second data group at the second worker for the first sub-epoch of the first epoch; a second task configured to train the second model configuration according to the third data group at the third worker for the second sub-epoch of the first epoch; and a third task configured to train the second model configuration according to the first data group at the first worker for the third sub-epoch of the first epoch.

Therefore, by generating the set of workloads configured to train the set of model configurations according to the set of data groups, the system can optimize concurrent execution of these workloads at the set of workers in order to scale deep learning model experimentation according to dataset size, model size, and quantity of concurrent model configuration experiments.

### 8.2 Resource Allocation

Generally, in Blocks S112 and S114, the system can allocate the cluster of resources in the set of workers to the set of workloads.

More specifically, for each workload in the set of workloads, the system can: identify a subcluster of resources in the cluster of resources that minimizes completion time of the workload based on the set of workloads and the cluster of resources; and allocate the subcluster of resources to the workload.

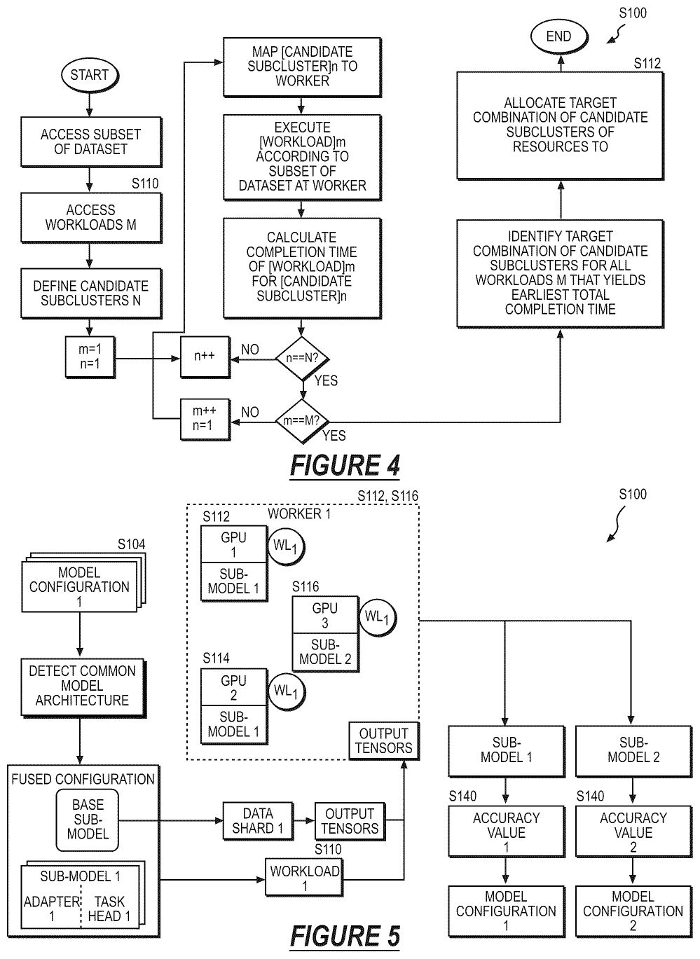

In one implementation, as shown in FIG. 4, the system: accesses a subset of (or a “mini-batch”) of the dataset; and, for each workload in the first set of workloads, defines a set of candidate subclusters of resources for the workload. Each candidate subcluster of resources is characterized by a quantity of graphics processing units.

In this implementation, for each candidate subcluster of resources in the set of candidate subclusters of resources, the system calculates a completion time estimate—in a set of completion time estimates for the set of workloads—to complete execution of the workload according to the subset of data via the candidate subcluster of resources.

More specifically, the system can: map the candidate subcluster of resources to a subset of resources (e.g., graphics processing units) in a worker(s) in the set of workers; schedule execution of the workload to train a model configuration according to the subset of the dataset via the candidate subcluster of resources mapped to the subset of resources in the worker; and to calculate the completion time estimate in response to execution of the workload via the candidate subcluster of resources.

For example, the system can define a first set of candidate subclusters of resources for the first workload including: a first candidate subcluster of resource characterized by one graphics processing unit; a second candidate subcluster of resource characterized by two graphics processing units; and a third candidate subcluster of resource characterized by a fourth graphics processing unit.

In this example, the system: maps the first candidate subcluster of resources to a first subset of resources (e.g., one graphics processing unit) in a first worker; schedules execution of the first workload to train the first model configuration according to the subset of the dataset via the first candidate subcluster of resources mapped to the first subset of resources in the first worker; and calculates a first completion time estimate—in the set of completion time estimates—to complete execution of the first workload.

The system repeats the foregoing methods and techniques for each candidate subcluster of resources in the first set of candidate subclusters of resources: to map the candidate subcluster of resources to a subset of resources in a worker; to schedule execution of the first workload via the candidate subcluster of resources; and to calculate a completion time estimate—in the set of completion time estimates—to complete execution of the first workload.

The system then repeats the foregoing methods and techniques for each workload in the first set of workloads.

Accordingly, the system can calculate completion time estimates for each workload in the set of workloads according to different candidate clusters of resources—characterized by different quantities of graphics processing units—in order to identify a target combination of subclusters of resources for allocation to the set of workloads that yields an earliest total completion time (or “makespan”) to complete execution of the set of workloads for an epoch.

For example, for each workload in the set of workloads, the system can select a target subcluster of resources—in the set of candidate subclusters of resources for the workload—that yields the earliest total completion time to complete execution of the set of workloads based on: the set of completion time estimates of the set of workloads; a total quantity of graphics processing units in the cluster of resources; and/or a heuristic (e.g., a greedy heuristic) that optimizes for the earliest total completion time.

Therefore, the system can: calculate completion time estimates for the set of workloads based on actual data (e.g., the “mini-batch”) in the dataset and actual resources of the set of workers; and identify the target combination of subclusters of resources for allocation to the set of workloads in order to reduce (or minimize) completion time of the set of workloads, thereby reducing time to accuracy and minimizing cost to the organization.

In another implementation, the system allocates a target subcluster of resources—in the target combination of subclusters of resources—to each workload in the set of workloads.

For example, the system can: allocate a first subcluster of resources (e.g., two graphics processing units) in the cluster of resources to the first workload for the first epoch; allocate a second subcluster of resources (e.g., one graphics processing unit) in the cluster of resources to the second workload for the first epoch; and allocate a third subcluster of resources (e.g., one graphics processing unit) in the cluster of resources to the third workload for the first epoch.

### 8.3 Workload Execution

Generally, in Block S116, the system can schedule concurrent execution of the set of workloads at the set of workers via the cluster of resources for the first epoch.

In one implementation, in response to allocating a set of subclusters of resources to the set of workloads, the system: maps the set of subclusters to a first combination of resources in the set of workers for a first sub-epoch in the first epoch; and schedules execution of the set of workloads (e.g., sets of tasks in each workload in the set of workloads) via the first combination of resources for the first sub-epoch.

For example, the system can: map the first subcluster of resources to a first set of resources in the first worker storing the first data group; map the second subcluster of resources to a second set of resources in the second worker storing the second data group; and map the third subcluster of resources to a third set of resources in the third worker storing the third data group.

In this example, the system can schedule execution of the set of workloads at the set of workers for the first sub-epoch.

Accordingly, for the first sub-epoch, the system schedules concurrent execution of: the first workload configured to train the first model configuration according to the first data group at the first worker; the second workload configured to train the second model configuration according to the second data group at the second worker; and the third workload configured to train the third model configuration according to the third data group at the third worker.

In another implementation, the system repeats the foregoing methods and techniques: to map the set of subclusters to a second combination of resources in the set of workers for a second sub-epoch in the first epoch; and to schedule execution of the set of workloads via the second combination of resources for the second sub-epoch.

For example, the system can: map the first subcluster of resources to the second set of resources in the second worker storing the second data group; map the second subcluster of resources to the third set of resources in the third worker storing the third data group; map the third subcluster of resources to the first set of resources in the first worker storing the first data group; and schedule execution of the set of workloads at the set of workers for the second sub-epoch.

The system repeats the foregoing methods and techniques for each sub-epoch in the first epoch: to map each subcluster of resources to resources in each worker in the set of workers; and to schedule execution of the set of workloads at the set of workers for the sub-epoch in order to execute each workload in the set of workloads according to each data group in the set of data groups.

Therefore, the system combines task parallelism and data parallelism to concurrently execute the set of workloads at the set of workers storing the set of data groups, thereby: minimizing communication overhead; minimizing memory and/or storage usage; maximizing graphics processing unit utilization; and maximizing throughput of the whole training process.

### 9. Visualization and Interactive Control

Block S120 of the method S100 recites calculating a first set of accuracy values representing accuracies of the set of model configurations responsive to execution of the first set of workloads for the first epoch.

The method S100 includes: generating a first visualization depicting the first set of accuracy values for the set of model configurations for the first epoch in Block S122; and serving the first visualization to a user via an interface in Block S124.

Generally, in Blocks S120, S122, S124, the system can: calculate a set of accuracy values representing accuracies of the set of model configurations for an epoch; generate a visualization depicting the set of accuracies; and serve the visualization to the user via an interface (e.g., a user interface).

In one implementation, in Block S120, the system calculates a first set of accuracy values representing accuracies of the set of model configurations for the first epoch, such as according to the accuracy function defined in the model-building specification.

For example, the first set of accuracy values can include: a first accuracy value representing a first accuracy of the first model configuration for the first epoch; a second accuracy value representing a second accuracy of the second model configuration for the first epoch; and a third accuracy value representing a third accuracy of the third model configuration for the first epoch.

More specifically, for each workload in the set of workloads, the system can: access a set of outputs (e.g., logits) responsive to execution of the workload for the first epoch; access a set of target outputs for the dataset; and calculate an accuracy value, in the set of accuracy values, for a model configuration associated with the workload for the first epoch based on a deviation between the set of outputs and the set of target outputs.

In particular, the system can: pass the set of outputs and the set of target outputs to the accuracy function defined in the model-building specification; and receive the accuracy value from the accuracy function.

In this implementation, the system: generates a first visualization depicting the first set of accuracy values in Block S122; and serves the first visualization to the user via the user interface in Block S124.

Therefore, by serving the visualization depicting accuracies of the set of model configurations, the system enables the user to identify a first subset of model configurations exhibiting relatively low accuracy and/or a second subset of model configurations exhibiting relatively high accuracy, thereby enabling the user to terminate model configurations in the first subset of model configurations in order to enable the system to automatically reallocate resources to model configurations in the second subset of model configurations (or based on model configurations in the second subset of model configurations).

Additionally, the system can: generate a first set of system metrics for the first epoch; and generate the first visualization depicting the first set of system metrics.

For example, the system can generate the first set of system metrics including: central processing unit utilization; graphics processing unit utilization; memory utilization; storage utilization; network traffic; graphics processing unit temperature (e.g., average temperature); a total quantity of central processing unit cores; a total quantity of active graphics processing units; a total memory; a total storage; etc.

### 9.1 Model Configuration Termination

In another implementation, the system receives a first command to terminate the first model configuration via the interface (e.g., the user interface, the programmatic application programming interface), such as in response to detection of the first accuracy value of the first model configuration failing to exceed a first threshold accuracy value (e.g., 50%).

For example, the system can: detect the first accuracy value of the first model configuration failing to exceed the first threshold accuracy value; generate the first visualization indicating failure of the first model configuration to exceed the first threshold accuracy value; and serve the first visualization to the user via the interface.

In response to receiving the first command, the system generates a second set of workloads: including the second workload and the third workload; and excluding the first workload in Block S130.

In this implementation, the system executes the foregoing methods and techniques to allocate subclusters of resources in the cluster of resources to the second set of workloads for a second epoch in the set of epochs in Block S132.

More specifically, the system can: release the first subcluster of resources allocated to the first workload for the first epoch; identifies a target workload in the second set of workloads that exhibits the greatest reduction in completion time based on a target subcluster of resources—allocated to the workload during the first epoch—and the first subcluster of resources (or a subset of the first subcluster of resources); and allocates a new subcluster of resources in the cluster of resources to the target workload. The new subcluster of resources includes: the target subcluster of resources allocated to the target workload during the first epoch; and the first subcluster of resources allocated to the first workload during the first epoch.

For example, for each workload in the second set of workloads, the system can calculate (or access) a first completion time estimate for the workload for the second epoch based on a target subcluster of resources allocated to the workload for the first epoch. The system can then calculate (or access) a second completion time estimate for the workload for the second epoch based on: the target subcluster of resources allocated to the workload for the first epoch; and the first subcluster of resources allocated to the first workload for the first epoch.

In this example, for each workload in the second set of workloads, the system can: calculate a completion time reduction—in a set of completion time reductions—for the workload based on a difference between the second completion time estimate and the first completion time estimate; and allocate the first subcluster of resources to a target workload associated with a greatest completion time reduction in the set of completion time reductions.

In particular, the system can calculate a first completion time reduction-in the set of completion time reductions—for the second workload; and, in response to detecting the second completion time reduction characterized as the greatest completion time reduction in the set of completion time reductions, allocate the first subcluster of resources and the second subcluster of resources to the second workload for the second epoch.

The system executes the foregoing methods and techniques: to schedule concurrent execution of the second set of workloads at the set of workers via the cluster of resources for the second epoch in the set of epochs in Block S134; to calculate a second set of accuracy values representing accuracies of the set of model configurations responsive to execution of the second set of workloads for the second epoch in Block S140; to generate a second visualization depicting the second set of accuracy values in Block S142; and to serve the second visualization to the user via the interface in Block S144.

Therefore, the system can render a control interface that enables the user: to identify a model configuration, or multiple model configurations, exhibiting relatively low accuracy during a model-training experiment; and to terminate the model configuration(s) in order to enable the system to automatically reallocate resources from that model configuration(s) to other model configurations exhibiting higher accuracy, thereby maximizing resource utilization and reducing time to accuracy.

### 9.2 Model Configuration Modification

In one variation, as shown in FIG. 3, the system receives a second command to modify the first model configuration via the interface, such as in response to detection of the first accuracy value of the first model configuration exceeding a second threshold accuracy (e.g., 80%).

For example, the system can: detect the first accuracy value of the first model configuration exceeding the second threshold accuracy value; generate the first visualization indicating the first model configuration exceeding the second threshold accuracy value; and serve the first visualization to the user via the interface.

In response to receiving the second command, the system defines a new model configuration (e.g., a fourth model configuration)—in the set of model configurations (or in a second set of model configurations including model configurations in the set of model configurations)—based on the first model configuration in Block S150.

For example, the system can define the new model configuration characterized by: the first model architecture; the first combination of hyperparameter values; and a new hyperparameter value excluded from the set of hyperparameter values (and/or a new hyperparameter excluded from the set of hyperparameters). The user interface enables the user to adjust these hyperparameter values anew based on their data science intuition about their application, the dataset, and the model configurations.

In this variation, the system executes the foregoing methods and techniques: to generate a second set of workloads for training the set of model configurations (or the second set of model configurations) according to the set of data groups in Block S152; and to allocate subclusters of resources in the cluster of resources to the second set of workloads for a second epoch in the set of epochs in Block S154.

For example, the system can generate the second set of workloads including: the first workload for training the first model configuration; the second workload for training the second model configuration; the third workload for training the second model configuration; and a fourth workload for training the new model configuration according to the set of data groups.

In this example, the system executes the foregoing methods and techniques: to calculate completion time estimates for each workload in the second set of workloads according to different candidate clusters of resources; and to identify a target combination of subclusters of resources for allocation to the second set of workloads that yields an earliest total completion time to complete execution of the second set of workloads for the second epoch.

More specifically, the system can: allocate a fourth subcluster of resources in the cluster of resources to the first workload for the first model configuration; allocate a fifth subcluster of resources in the cluster of resources to the second workload for the second model configuration; allocate a sixth subcluster of resources in the cluster of resources to the third workload for the third model configuration; and allocate a seventh subcluster of resources in the cluster of resources to the fourth workload for the new model configuration.

In this example, the system can allocate the fourth subcluster of resources (e.g., one graphics processing unit)—to the first workload—falling below the first subcluster of resources (e.g., two graphics processing units) allocated to the first workload for the first epoch.

In this variation, the system executes the foregoing methods and techniques: to schedule concurrent execution of the second set of workloads at the set of workers via the cluster of resources for the second epoch in Block S156; to calculate a second set of accuracy values representing accuracies of the set of model configurations (or the second set of model configurations) responsive to execution of the second set of workloads for the second epoch in Block S160; to generate a second visualization depicting the second set of accuracy values in Block S162; and to serve the second visualization to the user via the interface in Block S164.

Therefore, the system can render the control interface that enables the user: to identify a model configuration exhibiting relatively high accuracy; to duplicate and adjust this model configuration—during runtime execution of the second set of workloads—in order to modify model architecture, learning algorithm, hyperparameter combination, data preprocessing parameters (e.g., image size, time series window size, text embedding length), etc.; and to reallocate resources for training this model configuration during a subsequent epoch, thereby enabling rapid iteration and experimentation in order to reduce time to accuracy.

### 9.3 Model Configuration Suspension and Resumption

In another variation, the system executes similar methods and techniques described above to receive a third command to suspend (or pause) the first model configuration via the interface, such as for a second epoch in the set of epochs.

In response to receiving the third command, the system executes the foregoing methods and techniques to generate a second set of workloads: including the second workload and the third workload; and excluding the first workload.

In this variation, the system executes the foregoing methods and techniques: to allocate subclusters of resources in the cluster of resources to the second set of workloads for the second epoch; to schedule concurrent execution of the second set of workloads at the set of workers via the cluster of resources for the second epoch; to calculate a second set of accuracy values representing accuracies of the set of model configurations responsive to execution of the second set of workloads for the second epoch; to generate a second visualization depicting the second set of accuracy values; and to serve the second visualization to the user via the interface.

Then, the system can execute similar methods and techniques described above to receive a fourth command to resume the first model configuration via the interface, such as for a third epoch in the set of epochs,

In response to receiving the fourth command, the system executes the foregoing methods and techniques: to generate a third set of workloads for training the set of model configurations—including the first workload for training the first model configuration—according to the set of data groups; to allocate subclusters of resources in the cluster of resources to the third set of workloads for the third epoch; to schedule concurrent execution of the third set of workloads at the set of workers via the cluster of resources for the third epoch; to calculate a third set of accuracy values representing accuracies of the set of model configurations responsive to execution of the third set of workloads for the third epoch; to generate a third visualization depicting the third set of accuracy values; and to serve the third visualization to the user via the interface.

Therefore, the system can enable a user: to temporarily pause training for a target model configuration in order to reallocate compute resources—and/or focus user attention—to other model configurations; and to later resume or revisit the target model configuration for further training and/or refinement.

### 10. Subsequent Epochs

The system repeats the foregoing methods and techniques for each epoch in the set of epochs: to access (or generate) a set of workloads for the epoch; to allocate subclusters of resources in the cluster of resources to the set of workloads for the epoch; to schedule concurrent execution of the set of workloads at the set of workers via the cluster of resources for the epoch; to calculate a set of accuracy values representing accuracies of the set of model configurations responsive to execution of the set of workloads for the epoch; to generate a visualization depicting the set of accuracy values for the set of model configuration for the epoch; and to serve the visualization to the user via the interface.

### 11. Variation: Runtime Data Preprocessing

In one variation, the system executes the foregoing methods and techniques: to access a model-building specification; to access (or define) the set of model configurations based on the model-building specification; and to generate a set of workloads for training the set of model configurations according to the set of data groups.

For example, the system can access the model-building specification defining a set of data representations for the dataset, such as including: a first data representation characterized by a first image size; a second data representation characterized by a second image size different from the first image size; and a third data representation characterized by a third image size different from the first image size and the second image size.

In this example, the system can access (or define) the set of model configurations including: the first model configuration characterized by the first data representation; the second model configuration characterized by the second data representation; and the third model configuration characterized by the first data representation.

The system can then generate a set of workloads including: a first workload for training the first model configuration according to the set of data groups transformed into the first data representation, such as a first set of tensors representing the set of data groups and characterized by the first data representation (e.g., the first image size); a second workload for training the first model configuration according to the set of data groups transformed into the second data representation, such as a second set of tensors representing the set of data groups and characterized by the second data representation (e.g., the second image size); and a third workload for training the third model configuration according to the set of data groups transformed into the first data representation (e.g., the first set of tensors).

In this variation—rather than preprocessing the training dataset (e.g., raw data) into a transformed dataset, partitioning the transformed dataset into a set of data groups, and assigning the set of data groups to the set of workers—the system can: partition the training dataset into the set of data groups; assign the set of data groups to the set of workers; and transform (or preprocess) data according to a data representation characterizing a model configuration for execution of a workload associated with the model configuration.

For example, the system can: assign a first data group in the set of data groups to the first worker; assign a second data group in the set of data groups to the second worker; and assign a first data group in the set of data groups to the third worker.

The system can then execute the foregoing methods and techniques: to allocate subclusters of resources in the cluster of resources to the set of workloads for an epoch; and to schedule concurrent execution of the set of workloads at the set of workers via the cluster of resources for the epoch.

For example, at the first worker, the system can: access the first data group including sets of data (e.g., “raw” data); resize the sets of data according to the first data representation as resized sets of data; and generate the first set of tensors-representing the first data group and characterized by first data representation-based on the resized sets of data.

The system repeats the foregoing methods and techniques: to generate a second set of tensors representing the second data group and characterized by the second data representation at the second worker; and to generate a third set of tensors representing the third data group and characterized by the first data representation at the third worker. The system can store: the first set of tensors; the second set of tensors; and the third set of tensors.

In this example, the system then schedules concurrent execution of the set of workloads at the set of workers via the cluster of resources for a first epoch in the epoch.

Therefore, the system can preprocess the set of data groups during runtime execution (or “on the fly”) for the set of workloads in order to enable variation and/or experimentation of data representations for the set of model configurations.

The system can repeat the foregoing methods and techniques for each sub-epoch in the epoch.

For example, the system can execute the foregoing methods and techniques, for a second epoch in the set of epochs: to generate a third set of tensors representing the second data group and characterized by the first data representation at the second worker for the first workload; and to generate a fourth set of tensors representing the third data group and characterized by the second data representation at the third worker for the second workload. However, because the system generated and stored the first set of tensors—representing the first data group and characterized by first data representation—for the first sub-epoch, the system can omit (or bypass) generating an additional set of tensors representing the first data group and characterized by first data representation for the third workload.

In this example, the system can then schedule concurrent execution of the set of workloads at the set of workers via the cluster of resources for the second epoch in the epochs.

### 12. Variation: Model Shards

In one variation, the system executes the foregoing methods and techniques: to access (or define) the set of model configurations based on the model-building specification; and to generate a set of workloads for training the set of model configurations according to the set of data groups.

For example, the system can access the set of model configurations including the first model configuration characterized by the first model architecture, in the set of model architectures, characterized by a first memory size.

In this variation, in response to detection of the first model architecture exceeding a memory capacity of a graphics processing unit at a worker in the set of workers, the system partitions the first model architecture into a first set of sub-models (or “model shards”).

For example, the system can partition the first model architecture based on: a set of layers of the model architecture; a set of gradients associated with parameters of the model architecture; and/or a set of optimizer states.

In this example, the system partitions the first model architecture into the first set of sub-models including: a first sub-model; and a second sub-model. The first sub-model is characterized by: a first subset of layers in the set of layers; a first subset of gradients in the set of gradients; and/or a first subset of optimizer states in the set of optimizer states. The second sub-model is characterized by: a second subset of layers in the set of layers; a second subset of gradients in the set of gradients; and/or a second subset of optimizer states in the set of optimizer states.

In this variation, the system executes the foregoing methods and techniques to generate the set of workloads including a first workload for training the first model configuration according to the set of data groups. The first workload can include a first set of tasks including: a first task (or a first sub-task in a first task) configured to train the first sub-model according to the first data group at a first graphics processing unit in the first worker; and a second task (or a second sub-task in the first task) configured to train the second sub-model according to the first data group at a second graphics processing unit in the first worker.

The system can repeat the foregoing methods and techniques for each model in the first set of sub-models to generate a task (or sub-task) configured to train the sub-model according to the first data group at another graphics processing unit in the first worker (or at another graphics processing unit in another worker in the set of workers).

The system can repeat the foregoing methods and techniques for each data group in the set data groups to generate a subset of tasks, in the first set of tasks, configured to train a sub-model according to the data group at a worker.

Accordingly, the system can: define a model configuration characterized by a model architecture, which may exceed memory capacity of a single graphics processing unit at a worker; partition the model architecture into a sub-model—in a set of sub-models—that is deployable onto memory of the single graphics processing unit; generate a workload for training these sub-models; and schedule execution of this workload at graphics processing units of one or more workers.

Therefore, the system can optimize concurrent execution of workloads at the set of workers—each worker including multiple graphics processing units—in order to scale deep learning model experimentation according to dataset size, model size, and quantity of concurrent model configuration experiments.

### 13. Variation: Fused Configuration

In another variation, as shown in FIG. 5, the system executes the foregoing methods and techniques to access (or define) the set of model configurations including: a first model configuration; and a second model configuration. The first model configuration is characterized by: the first model architecture (e.g., a large language model architecture, a vision language model architecture, a multimodal model architecture); and the first combination of hyperparameter values. The second model configuration is characterized by: the first model architecture; and the second combination of hyperparameter values.

In this variation, the system detects the first model architecture characterizing the first model configuration and the second model configuration. In response to detection of the first model architecture characterizing the first model configuration and the second model configuration, the system defines a fused model configuration, in the set of model configurations, representing a combination of the first model configuration and the second model configuration.

More specifically, the system can define the fused model configuration characterized by: a base sub-model—shared by the first model configuration and the second model configuration—representing a first sub-graph (e.g., a first subset of layers) for the first model architecture; a first sub-model representing a second sub-graph (e.g., a second subset of layers) specific to the first model configuration for the first model architecture; and a second sub-model representing a third sub-graph (e.g., a third subset of layers) specific to the second model configuration for the first model architecture.

For example, the system can define the first sub-model characterized by: a first adapter representing the second sub-graph; a first task head associated with the first adapter; and a first set of optimizer states.

In this example, the system can define the second sub-model characterized by: a second adapter representing the third sub-graph; a second task head associated with the second adapter; and a second set of optimizer states.

In this variation, the system executes the foregoing methods and techniques to generate a first set of workloads for a first epoch. The first set of workloads include a first workload—including a first set of tasks—for training the fused model configuration according to the set of data groups.

For example, the first set of tasks can include a first task configured to train the first sub-model at a first graphics processing unit in a worker (e.g., the first worker) according to: a set of output tensors for the base sub-model according to a data group (e.g., the first data group), in the set of data groups, assigned to the worker; and the first combination of hyperparameter values.

In this example, the first set of tasks can include a second task configured to train the second sub-model at a second graphics processing unit in the worker according to: the set of output tensors for the base sub-model according to the data group assigned to the worker; and the second combination of hyperparameter values.

In this variation, the system executes the foregoing methods and techniques to allocate subclusters of resources in the cluster of resources to the first set of workloads for the epoch; and to schedule concurrent execution of the first set of workloads at the set of workers via the cluster of resources for the first epoch.

For example, the system can execute the foregoing methods and techniques: to allocate a first subcluster of resources (e.g., two graphics processing units) in the cluster of resources to the first workload for the first epoch; to map the first subcluster of resources to a first set of resources (e.g., the first graphics processing unit, the second graphics processing unit) in the first worker storing the first data group; and to schedule execution of the first workload for a first sub-epoch in the first epoch.

In this example, the system: accesses the base sub-model representing the first sub-graph for the second model architecture; passes the first data group through the base sub-model to generate a first set of output tensors for the base sub-model; trains the first sub-model at the first graphics processing unit in the first worker according to the first task; and trains the second sub-model at the second graphics processing unit in the first worker according to the second task.

More specifically, the system can: train the first adapter and/or the first task head according to the first set of output tensors and the first combination of hyperparameters; and train the second adapter and/or the second task head according to the first set of output tensors and the second combination of hyperparameters.

Additionally, the system can access: a first subset of outputs (e.g., logits)—in a first set of outputs—responsive to execution of the first task at the first graphics processing unit in the first worker; and a second subset of outputs, in a second set of outputs, responsive to execution of the second task at the second graphics processing unit in the first worker.

The system repeats the foregoing methods and techniques for each sub-epoch in the first epoch: to pass a data group through the base sub-model to generate a set of output tensors for the base sub-model; to train the first sub-model at a graphics processing unit in a worker storing the data group according to the set of output tensors and the first combination of hyperparameters for the sub-epoch; to train the second sub-model at a different graphics processing unit in the worker according to the set of output tensors and the second combination of hyperparameters for the sub-epoch; to access a subset of outputs in the first set of outputs responsive to training the first sub-model for the sub-epoch; and to access another subset of outputs in the second set of outputs responsive to training the second sub-model for the sub-epoch.

In this variation, in response to completion of the first epoch, the system executes similar methods and techniques described above: to calculate a first accuracy value—in a first set of accuracy values—representing a first accuracy of the first sub-model based on the first set of outputs; and to calculate a second accuracy value, in the first set of accuracy values, representing a second accuracy of the second sub-model based on the second set of outputs.

More specifically, the system can: record a first checkpoint representing a first subset of weights for the first sub-model; record a second checkpoint representing a second subset of weights for the second sub-model; extract the first sub-model (e.g., the first adapter, the first task head, the first set of optimizer states)—trained for the first epoch—from the fused configuration; extract the second sub-model (e.g., the second adapter, the second task head, the second set of optimizer states) trained for the first epoch from the fused configuration; compile (or loads, “rewrites”) the first sub-model into the first model configuration; compile the second sub-model into the second model configuration; assigns the first accuracy value to the first model configuration; and assign the second accuracy value to the second model configuration.

Accordingly, rather than loading two models for the first model configuration and the second model configuration onto a worker for a sub-epoch, the system can: combine architectural specifications for the first model configuration and the second model configuration into a single architectural specification—or a “fused model” characterized by a shared base model (e.g., shared base weights) and separate adapters for the first model configuration and the second model configuration—for a fused configuration; load the fused model onto the worker for training the fused configuration; extract the adapters from the fused model responsive to execution (e.g., training) at the worker; compile (or “rewrite”) these adapters to the first model configuration and the second model configuration; and serve accuracy values for the first model configuration and the second model configuration to the user.

Therefore, the system can enable the user to control and monitor model training experimentation—such as for adapter fine-tuning, post-training, and/or transfer learning with large language models—for multiple concurrent model configurations while executing (and/or sharing base weights of) a single model for training multiple adapters at graphics processing units in a single work, thereby: reducing a graphics processing unit memory footprint; bypassing redundant computations (e.g., for the base model) across the model configurations; and/or reducing completion time (or runtime) for these model configurations.

### 14. Variation: Single-Worker Computing Platform

As described herein, the system executes Blocks of the method S100: to allocate subclusters of resources—in a cluster of resources of a set of (e.g., multiple) workers—to the set of workloads for an epoch; and to schedule concurrent execution of the set of workloads at the set of workers via the cluster of resources.

However, the system can similarly execute Blocks of the method S100: to allocate subclusters of resources (e.g., subsets of graphics processing units)—in a cluster of resources (e.g., a set of graphics processing units) of a worker (e.g., a computing platform including one worker)—to the set of workloads for an epoch; and to schedule concurrent execution of the set of workloads at the worker via the cluster of resources.

For example, as shown in FIG. 3, the system can execute the foregoing methods and techniques to access a set of model configurations including: a first model configuration characterized by a first combination of hyperparameter values; a second model configuration characterized by a second combination of hyperparameter values; and a third model configuration characterized by a third combination of hyperparameter values.

Additionally, the system can execute the foregoing methods and techniques: to partition a dataset into a set of data groups; and assign the set of data groups to the set of graphics processing units in the worker.

In this example, the system can execute the foregoing methods and techniques to generate a first set of workloads including: a first workload for training the first model configuration according to a dataset; a second workload for training the second model configuration according to the dataset; and a third workload for training the third model configuration according to the dataset.

The system can then execute the foregoing methods and techniques: to allocate a first subset of graphics processing units in the set of graphics processing units to the first workload for a first epoch; to allocate a second subset of graphics processing units in the set of graphics processing units to the second workload for the first epoch; and to allocate a third subset of graphics processing units in the set of graphics processing units to the third workload for the first epoch.

The system can then execute the foregoing methods and techniques: to schedule concurrent execution of the set of workloads at the worker via the cluster of resources for the epoch; to calculate a set of accuracy values representing accuracies of the set of model configurations responsive to execution of the set of workloads for the epoch; to generate a visualization depicting the set of accuracy values for the set of model configuration for the epoch; and to serve the visualization to the user via the interface.

In one variation, in response to detection of the first accuracy value failing to exceed a first threshold accuracy value and/or receiving the first command to terminate the first model configuration, the system can execute the foregoing methods and techniques to generate a second set of workloads: including the second workload and the third workload; and excluding the first workload.

In this variation, the system executes the foregoing methods and techniques to allocate subclusters of resources—in a cluster of resources of the worker—to the second set of workloads for a second epoch.

For example, the system can: allocate a fourth subset of graphics processing units in the set of graphics processing units to the second workload for the second epoch; and allocate a fifth subset of graphics processing units in the set of graphics processing units to the third workload for the second epoch.

In this example, the fourth subset of graphics processing units includes: the second subset of graphics processing units; and a first graphics processing unit in the first subset of graphics processing units allocated to the first workload for the first epoch. The fifth subset of graphics processing units includes: the third subset of graphics processing units; and a second graphics processing unit in the first subset of graphics processing units allocated to the first workload for the first epoch.

The system can then execute the foregoing methods and techniques: to schedule concurrent execution of the set of workloads at the set of workers via the cluster of resources for the second epoch; to calculate a second set of accuracy values representing accuracies of the set of model configurations responsive to execution of the set of workloads for the second epoch; to generate a second visualization depicting the second set of accuracy values for the set of model configuration for the second epoch; and to serve the second visualization to the user via the interface.

In another variation, in response to detection of the first accuracy value exceeding the second threshold accuracy value and/or receiving the second command to terminate the first model configuration, the system executes the foregoing methods and techniques to generate a second set of workloads including: the first workload for the first model configuration; the second workload; the third workload; and a new workload for a new model configuration based on the first model configuration.

The system can then execute the foregoing methods and techniques: to allocate subclusters of resources in the cluster of resources to the set of workloads for a second epoch; to schedule concurrent execution of the second set of workloads at the worker via the cluster of resources for the second epoch; to calculate a second set of accuracy values representing accuracies of the set of model configurations responsive to execution of the set of workloads for the second epoch; to generate a second visualization depicting the second set of accuracy values for the set of model configuration for the second epoch; and to serve the second visualization to the user via the interface.

### 15. Disclaimers

The systems and methods described herein can be embodied and/or implemented at least in part as a machine configured to receive a computer-readable medium storing computer-readable instructions. The instructions can be executed by computer-executable components integrated with the application, applet, host, server, network, website, communication service, communication interface, hardware/firmware/software elements of a user computer or mobile device, wristband, smartphone, or any suitable combination thereof. Other systems and methods of the embodiment can be embodied and/or implemented at least in part as a machine configured to receive a computer-readable medium storing computer-readable instructions. The instructions can be executed by computer-executable components integrated with apparatuses and networks of the type described above. The computer-readable medium can be stored on any suitable computer readable media such as RAMs, ROMs, flash memory, EEPROMs, optical devices (CD or DVD), hard drives, floppy drives, or any suitable device. The computer-executable component can be a processor, but any suitable dedicated hardware device can (alternatively or additionally) execute the instructions.

As a person skilled in the art will recognize from the previous detailed description and from the figures and claims, modifications and changes can be made to the embodiments of the invention without departing from the scope of this invention as defined in the following claims.

I claim:

1. A method for orchestrating model-training experimentation on a set of workers comprising a cluster of resources, the method comprising:
accessing a model-building specification defining:
a set of hyperparameters for training a set of model architectures; and
a set of hyperparameter values for the set of hyperparameters;
accessing a set of model configurations comprising:
a first model configuration characterized by a first combination of hyperparameter values in the set of hyperparameter values; and
a second model configuration characterized by a second combination of hyperparameter values in the set of hyperparameter values;
partitioning a dataset into a set of data groups;
assigning the set of data groups to the set of workers;
generating a first set of workloads comprising:
a first workload for training the first model configuration according to the set of data groups; and
a second workload for training the second model configuration according to the set of data groups;
allocating subclusters of resources in the cluster of resources to the first set of workloads for a first epoch in a set of epochs;
scheduling concurrent execution of the first set of workloads at the set of workers via the cluster of resources for the first epoch;
calculating a first set of accuracy values, representing accuracies of the set of model configurations responsive to execution of the first set of workloads for the first epoch, comprising a first accuracy value representing a first accuracy of the first model configuration for the first epoch;
in response to detection of the first accuracy value failing to exceed a first threshold accuracy value, generating a second set of workloads:
comprising the second workload; and
excluding the first workload;
allocating subclusters of resources in the cluster of resources to the second set of workloads for a second epoch in the set of epochs; and
scheduling concurrent execution of the second set of workloads at the set of workers via the cluster of resources for the second epoch.

2. The method of claim 1:
further comprising:
generating a first visualization depicting the first set of accuracy values for the set of model configurations for the first epoch; and
serving the first visualization to a user via an interface; and
wherein generating the second set of workloads comprises generating the second set of workloads in response to:
detection of the first accuracy value of the first model configuration failing to exceed the first threshold accuracy value; and
receiving a command to terminate the first model configuration via the interface.

3. The method of claim 1, further comprising:
calculating a second set of accuracy values, representing accuracies of the set of model configurations responsive to execution of the second set of workloads for the second epoch, comprising a second accuracy value representing a second accuracy of the second model for the second epoch;
in response to detection of the second accuracy value exceeding a second threshold accuracy value, defining a second set of model configurations comprising:
the second model configuration; and
a third model configuration based on the second model configuration, the second model configuration characterized by:
the second combination of hyperparameter values; and
a target hyperparameter value for a target hyperparameter excluded from the set of hyperparameter values;
generating a third set of workloads comprising:
the second workload; and
a third workload for training the third model configuration according to the set of data groups;
allocating subclusters of resources in the cluster of resources to the third set of workloads for a third epoch in the set of epochs; and
scheduling concurrent execution of the third set of workloads at the set of workers via the cluster of resources for the third epoch.

4. The method of claim 1:
wherein allocating subclusters of resources to the first set of workloads for the first epoch comprises:
allocating a first subcluster of resources in the cluster of resources to the first workload for the first epoch; and
allocating a second subcluster of resources in the cluster of resources to the second workload for the first epoch; and
wherein allocating subclusters of resources in the cluster of resources to the second set of workloads for the second epoch comprises:
releasing the first subcluster of resources allocated to the first workload for the first epoch; and
allocating the first subcluster of resources and the second subcluster of resources to the second workload for the second epoch, the first subcluster of resources and the second subcluster of resources representing graphics processing units in the set of workers.

5. The method of claim 4, wherein allocating the first subcluster of resources and the second subcluster of resources to the second workload for the second epoch comprises:
for each workload in the second set of workloads:
calculating a first completion time estimate for the workload for the second epoch based on a subcluster of resources allocated to the workload for the first epoch;
calculating a second completion time estimate for the workload for the second epoch based on:
the subcluster of resources allocated to the workload for the first epoch; and
the first subcluster of resources allocated to the first workload for the first epoch;
calculating a completion time reduction, in a set of completion time reductions, for the workload based on a difference between the second completion time estimate and the first completion time estimate, the set of completion time reductions comprising a target completion time reduction for the second workload; and
in response to detecting the target completion time reduction characterized as a greatest completion time reduction in the set of completion time reductions, allocating the first subcluster of resources and the second subcluster of resources to the second workload for the second epoch.

6. The method of claim 1:
wherein partitioning the dataset comprises:
calculating a quantity of workers in the set of workers; and
segmenting the dataset into the set of data groups according to the quantity of workers, the set of data groups comprising:
a first data group; and
a second data group;
wherein assigning the set of data groups comprises:
assigning the first data group to the first worker; and
assigning the second data group to the second worker;
wherein generating the first set of workloads comprises generating the first workload comprising a first set of tasks comprising:
a first task configured to train the first model configuration according to the first data group at the first worker for a first sub-epoch in the first epoch; and
a second task configured to train the first model configuration according to the second data group at the second worker for a second sub-epoch in the first epoch; and
wherein scheduling concurrent execution of the first set of workloads at the set of workers comprises scheduling execution of the first set of tasks at the set of workers for the first epoch.

7. The method of claim 6:
wherein allocating subclusters of resources to the first set of workloads for the first epoch comprises allocating a first subcluster of resources in the cluster of resources to the first workload for the first epoch; and
wherein scheduling execution of the first set of tasks at the set of workers for the first epoch comprises:
mapping the first subcluster of resources to a first set of graphics processing units in the first worker for the first sub-epoch; and
mapping the first subcluster of resources to a second set of graphics processing units in the second worker for second sub-epoch.

8. The method of claim 6:
wherein accessing the set of model configurations comprises:
accessing the first model configuration characterized by a first model architecture, in the set of model architectures, characterized by a memory size; and
in response to detecting the memory size exceeding a memory capacity of a graphics processing unit in a worker in the set of workers, partitioning the first model architecture into a first set of sub-models; and
wherein generating the first workload comprises generating the first task comprising:
a first sub-task configured to train a first sub-model in the first set of sub-models according to the first data group at a first graphics processing unit in the first worker; and
a second sub-task configured to train a second sub-model in the first set of sub-models according to the first data group at a second graphics processing unit in the first worker.

9. The method of claim 8, wherein partitioning the first model architecture comprises partitioning the first model architecture into the first set of sub-models comprising the first sub-model characterized by:
a first subset of layers in a set of layers of the first model architecture; and
a first subset of gradients in a set of gradients associated with parameters of the first model architecture.

10. The method of claim 1:
wherein accessing the set of model configurations comprises accessing the set of model configurations comprising:
the first model configuration characterized by a first data representation for the dataset; and
the first model configuration characterized by a second data representation, different from the first data representation for the dataset;
wherein assigning the set of data groups comprises:
assigning a first data group in the set of data groups to the first worker; and
assigning a second data group in the set of data groups to the second worker; and
wherein generating the first set of workloads comprises generating the first set of workloads comprising:
the first workload for training the first model configuration according to a first set of tensors:
representing the set of data groups; and
characterized by the first data representation; and
the second workload for training the second model configuration according to a second set of tensors:
representing the set of data groups; and
characterized by the second data representation.

11. The method of claim 10, wherein scheduling concurrent execution of the first set of workloads comprises:
at the first worker, transforming the first data group into the first set of tensors according to the first data representation for the first workload; and
at the second worker, transforming the second data group into the second set of tensors according to the second data representation for the second workload.

12. The method of claim 1, wherein allocating subclusters of resources to the first set of workloads for the first epoch comprises:
accessing a subset of the dataset; and
for each workload in the first set of workloads:
defining a set of candidate subclusters of resources for the workload, each candidate subcluster of resources characterized by a quantity of graphics processing units;
for each candidate subcluster of resources in the set of candidate subclusters of resources:
calculating a completion time estimate, in a set of completion time estimates for the first set of workloads, to complete execution of the workload according to the subset of data via the candidate subcluster of resources; and
selecting a target subcluster of resources in the set of candidate subclusters of resources for the workload that yields an earliest total completion time to complete execution of the first set of workloads based on:
the set of completion time estimates; and
a total quantity of graphics processing units in the cluster of resources.

13. The method of claim 1:
wherein accessing the set of model configurations comprises:
accessing the set of model configurations comprising:
a third model configuration characterized by:
a second model architecture in the set of model architectures; and
a third combination of hyperparameter values in the set of hyperparameter values; and
a fourth model configuration characterized by:
the second model architecture; and
a fourth combination of hyperparameter values in the set of hyperparameter values; and
in response to detecting the second model architecture characterizing the third model configuration and the fourth model configuration, defining a fused model configuration in the set of model configurations:
representing a combination of the third model configuration and the fourth model configuration; and
characterized by:
a base sub-model representing a first sub-graph for the second model architecture;
a first sub-model representing a second sub-graph for the second model architecture; and
a second sub-model representing a third sub-graph for the second model architecture; and
wherein generating the first set of workloads comprises generating the first set of workloads comprising a third workload for training the fused model configuration according to the set of data groups, the third workload comprising a first set of tasks comprising:
a first task configured to train the first sub-model at a first graphics processing unit in the first worker according to:
a set of output tensors for the base sub-model according to the first data group; and
the third combination of hyperparameter values; and
a second task configured to train the second sub-model at a second graphics processing unit in the first worker according to:
the set of output tensors; and
the fourth combination of hyperparameter values.

14. The method of claim 13:
wherein defining the fused model configuration comprises:
defining the fused model configuration characterized by:
the first sub-model characterized by:
a first adapter representing the second sub-graph; and
a first task head associated with the first adapter; and
the second sub-model characterized by;
a second adapter representing the third sub-graph; and
a second task head associated with the second adapter;
wherein scheduling concurrent execution of the first set of workloads comprises:
passing the first data group through the base sub-model to generate the set of output tensors for the base sub-model; and
wherein calculating the first set of accuracy values comprises calculating the first set of accuracy values comprising:
a third accuracy value representing a third accuracy of the third model configuration based on a first set of outputs responsive to execution of the first task; and
a fourth accuracy value representing a fourth accuracy of the fourth model configuration based on a second set of outputs responsive to execution of the second task.

15. The method of claim 1, wherein calculating the first set of accuracy values comprises, for workload in the first set of workloads:
accessing a set of outputs responsive to execution of the workload for the first epoch;
accessing a set of target outputs for the dataset; and
calculating an accuracy value, in the first set of accuracy values, for a model configuration associated with the workload for the first epoch based on a deviation between the set of outputs and the set of target outputs.

16. A method for orchestrating model-training experimentation on a set of workers comprising a cluster of resources, the method comprising:
accessing a model-building specification defining:
a set of model architectures;
a set of hyperparameters for training the set of model architectures; and
a set of hyperparameter values for the set of hyperparameters;
accessing a set of model configurations comprising:
a first model configuration characterized by a first combination of hyperparameter values in the set of hyperparameter values; and
a second model configuration characterized by a second combination of hyperparameter values in the set of hyperparameter values;
partitioning a dataset into a set of data groups;
assigning the set of data groups to the set of workers;
generating a first set of workloads comprising:
a first workload for training the first model configuration according to the set of data groups; and
a second workload for training the second model configuration according to the set of data groups;
allocating subclusters of resources in the cluster of resources to the first set of workloads for a first epoch in a set of epochs of a model-training experiment;
scheduling concurrent execution of the first set of workloads at the set of workers via the cluster of resources for the first epoch;
calculating a first accuracy value representing a first accuracy of the first model configuration responsive to execution of the first set of workloads for the first epoch;
in response to detection of the first accuracy value exceeding a first threshold accuracy value, defining a second set of model configurations comprising:
the first model configuration;
the second model configuration; and
a third model configuration based on the first model configuration, the third model configuration characterized by:
the first combination of hyperparameter values; and
a target hyperparameter value for a target hyperparameter excluded from the set of hyperparameter values;
generating a second set of workloads comprising:
the first workload;
the second workload; and
a third workload for training the third model configuration according to the set of data groups;
allocating subclusters of resources in the cluster of resources to the second set of workloads for a second epoch in the set of epochs; and
scheduling concurrent execution of the second set of workloads at the set of workers via the cluster of resources for the second epoch.

17. The method of claim 16:
wherein generating the first set of workloads comprises generating the first workload representing:
a first task configured to train the first model configuration according to a first data group in the set of data groups at the first worker for a first sub-epoch in the first epoch; and
a second task configured to train the first model configuration according to the second data group in the set of data groups at the second worker for a second sub-epoch in the first epoch;
wherein allocating subclusters of resources in the cluster of resources to the first set of workloads for the first epoch comprises allocating a first subcluster of resources in the cluster of resources to the first workload for the first epoch; and
scheduling concurrent execution of the first set of workloads at the set of workers via the cluster of resources for the first epoch comprises:
mapping the first subcluster of resources to a first set of graphics processing units in the first worker for the first sub-epoch; and
mapping the first subcluster of resources to a second set of graphics processing units in the second worker for the second sub-epoch.

18. The method of claim 16:
further comprising:
generating a visualization depicting the first accuracy value of the first model configuration for the first epoch; and
serving the first visualization to a user via an interface; and
wherein generating the second set of workloads comprises generating the second set of workloads in response to:
detection of the first accuracy value of the first model configuration exceeding the threshold accuracy value; and
receiving a command to modify the first model configuration via the interface.

19. A method for orchestrating model-training experimentation on a worker comprising a set of graphics processing units:
accessing a model-building specification defining:
a set of hyperparameters for training the set of model architectures; and
a set of hyperparameter values for the set of hyperparameters;
accessing a set of model configurations comprising:
a first model configuration characterized by a first combination of hyperparameter values in the set of hyperparameter values; and
a second model configuration characterized by a second combination of hyperparameter values in the set of hyperparameter values;
generating a first set of workloads comprising:
a first workload for training the first model configuration according to a dataset; and
a second workload for training the second model configuration according to the dataset;
allocating a first subset of graphics processing units in the set of graphics processing units to the first workload for a first epoch;
allocating a second subset of graphics processing units in the set of graphics processing units to the second workload for the first epoch;
scheduling concurrent execution of the first set of workloads at the worker via the set of graphics processing units for the first epoch;
calculating a first accuracy value representing a first accuracy of the first model configuration responsive to execution of the first workload for the first epoch;
in response to detection of the first accuracy value failing to exceed a threshold accuracy value, generating a second set of workloads:
comprising the second workload; and
excluding the first workload;
allocating a third subset of graphics processing units in the set of graphics processing units to the second workload for a second epoch, the third subset of graphics processing units comprising:
a graphics processing unit in the first subset of graphics processing units; and
the second subset of graphics processing units; and
scheduling concurrent execution of the second set of workloads at the worker via the set of graphics processing units for the second epoch.

20. The method of claim 19:
wherein calculating the first accuracy value comprises calculating a set of accuracy values representing accuracies of the set of model configurations responsive to execution of the first set of workloads for the first epoch, the first set of accuracy values comprising the first accuracy value;
further comprising:
generating a visualization depicting the set of accuracy values;
serving the visualization to a user via an interface; and
receiving a command to terminate the first model configuration via the interface; and
wherein generating the second set of workloads comprises generating the second set of workloads in response to:
detection of the first accuracy value of the first model configuration failing to exceed the threshold accuracy value; and
receiving the first command.
